(19) United States
(12) Patent Application Publication
(10) Pub. No.: US 2010/0215150 A1
(43) Pub. Date: Aug. 26, 2010

(54) Real-time Assisted Guidance System for a Radiography Device

(76) Inventors: Jean-Noël Vallee, Paris (FR); Christophe Nioche, Paris (FR); Patrick Sabbah, Los Angeles, CA (US)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 12/627,569

(22) Filed: Nov. 30, 2009

Related U.S. Application Data
(63) Continuation-in-part of application No. 10/510,306, filed on Mar. 12, 2007, now abandoned.

(30) Foreign Application Priority Data
Apr. 5, 2002 (FR) 02/04296

(51) Int. Cl. H05G 1/64

(52) U.S. Cl. 378/98.12; 378/4

(57) ABSTRACT

The invention provides a real-time method for navigation inside a region of interest, for use in a radiography unit including an X-ray source with an X-ray detector facing the source (cradle), and a support (table) on which an object to be radiographied, containing the region of interest, can be positioned.

The method comprising the following steps:
a) acquiring three-dimensional image data of a volume V1 of the region of interest;
b) per-operatively, calculating, at a time t, a volume (V2, V3) of all or part of volume V1 and/or a two-dimensional projection image (IP2, IP3) of all or part of volume V1 according to the radiographic parameters of the position of the support, the position of the source and recording means, a field of view (FOV), a focal distance (DF) and an object distance (DO);
c) per-operatively, real-time combining the volume (V3) and/or the projection image (IP3) and/or a given plane section in the volume (V3), with the real-time images (IS1) and/or volumes (VS1) of videoscopy, resulting in volume (V4) and/or projection image (IP4) of volume V4 associated with the positions of the support, of the source and recording means, of the field of view (FOV), of the focal distance (DF) and the object distance (DO);
d) per-operatively, real-time displaying on a display device, the video sequence of the volume (VR) and/or the projection image (IP) resulting from step b);
e) per operatively, real-time displaying on a display device, the video sequence of the volume (VRS) and/or the image (IR) resulting from step c)

### CROSS-REFERENCE TO RELATED APPLICATIONS

This application is a continuation-in-part of U.S. patent application Ser. No. 10/510,306, filed Mar. 12, 2007, which is a national stage of international application No. PCT/FR03/01075, the entire disclosures of which are hereby expressly incorporated by reference herein.

### BACKGROUND OF THE INVENTION

The present invention concerns a guidance aiding system supported by imaging, for instruments and equipment inside a region of interest.

A volume in the region of interest is an object volume with no limitation of representation regarding the external or internal form of the object, obtained from any imaging technique capable of producing such volumes.

Real-time active images are real-time animated images obtained from any imaging technique capable of producing these images.

Instruments and equipment are instrumentations which can be visualized with the imaging technique that produces the real-time active images.

At present, interventional radiology procedures assisted by angiography imaging, for example, for the investigation or the treatment of an anatomic region of interest, are presently carried out with a radio-guidance aiding system based on plane reference images according to 2 possible modes of radioscopy:
Radioscopy in superposition mode consists in superposing a plane reference image, subtracted or not, with inverted contrast or non-inverted contrast, previously acquired and stored, on the radioscopic image with the possibility of changing the mixing percentage of the reference image.
Radioscopy in so-called “road-map” mode is a subtracted radioscopy. A subtracted plane image is generated during the radioscopy for use as a mask for the following radioscopies. In the vascular domain, an injection of contrast substance during the generation of the subtracted image produces a vascular cartography used as a reference mask for the following radioscopies. The opacified image of the vessels is subtracted from the active radioscopic image with a possibility to mix in variable proportion an anatomic background with the subtracted image.

Radioscopies in superposition mode and so-called “road-map’ mode provide radio-guiding assistance according to the plane of the reference image, i.e. the projection plane of the image determined by the position of the cradle, the position of the anatomic region of interest, which depends from the position of the examination table, and according to the enlargement and scale of the reference image, which depend on the value of the field of vision and the geometric enlargement determined by the relation between the focal distance of the X-ray source to the recording system and the distance separating the X-ray source and the radiographied object. These modes of radioscopy have several disadvantages.

Firstly, for any change in the plane of the reference image, in the position of the anatomical region of interest, in the image enlargement or scale, the operator must either acquire and store a new reference image in the case of superposition mode radioscopy, or generate a new subtracted reference image in the case of road-map radioscopy. These iterative procedures result in lengthening the intervention and radiation durations, and increasing the quantities of contrast substance injected into the patient.

Secondly, when new subtracted reference images are acquired or generated respectively in the case of superposition mode with subtracted reference image radioscopy, and road-map mode radioscopy, there is during the intervention a loss of information concerning the display of instruments and radio-opaque treating equipment in place due to their subtraction from the reference image. In the case of superposition mode radioscopy with non-subtracted reference image, the definition and distinction of the adjacent anatomic structures depend on the differences in radio-opacity between these structures and cause a problem when radio-opacities thereof are very close or not different enough such as in an opacified vascular, channel-like of cavity-like structure in relation with an adjacent bone structure.

Superposition mode and road-map mode radioscopies provide radio-guiding assistance based on plane reference images fixed in the reference plane, that need to be acquired or generated a priori. These reference images do not provide any information on the third dimension of the region of interest, which limits and restricts the radio-guiding assistance by these two modes of radioscopy.

### BRIEF SUMMARY OF THE INVENTION

An aim of the present invention is to provide an improved navigation system with respect to the above issues.

The invention provides for that purpose a real-time method for navigation inside a region of interest, for use in a radiography unit including an X-ray source with an X-ray detector facing the source (cradle), and a support (table) on which an object to be radiographied, containing the region of interest, can be positioned.

The method comprising the following steps:
a) acquiring three-dimensional image data of a volume V1 of the region of interest;
b) per-operatively, calculating, at a time t, a volume (V2, V3) of all or part of volume V1 and/or a two-dimensional projection image (IP2, IP3) of all or part of volume V1 according to the radiographic parameters of the position of the support, the position of the source and recording means, a field of view (FOV), a focal distance (DF) and an object distance (DO);
c) per-operatively, real-time combining the volume (V3) and/or the projection image (IP3) and/or a given plane section in the volume (V3), with the real-time images (IS1) and/or volumes (VS1) of videoscopy, resulting in volume (V4) and/or projection image (IP4) of volume V4 associated with the positions of the support, of the source and recording means, of the field of view (FOV), of the focal distance (DF) and the object distance (DO);
d) per-operatively, real-time displaying on a display device, the video sequence of the volume (VR) and/or the projection image (IP) resulting from step b);
e) per operatively, real-time displaying on a display device, the video sequence of the volume (VRS) and/or the image (IR) resulting from step c)

Therefore, as soon as one of the cited parameters is changed, the system automatically calculates in real-time the displayed volumes and volume projection image. Consequently, the user has constant optimal display of the volume and/or projection image of the region of interest volume <<visualized>> by the radiography system, without any additional means of radiography or radioscopy, thus reducing the amount of radiation generated during the intervention, either from the resulting volume and/or resulting superposition or subtraction or fusion image, according to a plane section defined in the volume and/or on the volume projection image, of the radioscopic image of corresponding parameterization, which makes it possible for the user to optimize instrumentation guiding, control of technical intervention and evaluation of technical intervention in real-time.

Optionally, the method includes at least one of the following additional features:
step b) includes the following sub-steps, per-operatively:
   b1) reading, at a time t, in the storage means of the radiographic parameters of a support position (x, y, z)₍ₜ₎, a source and recording means position (α, β, γ)₍ₜ₎, the field of view (FOV)₍ₜ₎, the focal distance (DF)₍ₜ₎ and the object distance (DO)₍ₜ₎; and
   b2) calculating, at a time t, volume (V3, VR)₍ₜ₎ and/or the projection image (IP, IP3)₍ₜ₎ according to the read parameters (x, y, z)₍ₜ₎, (α, β, γ)₍ₜ₎, (FOV)₍ₜ₎, (DF)₍ₜ₎ and (DO)₍ₜ₎.
step b) includes the following sub-steps per-operatively:
   b1) reading, at a time t, in the storage means of the radiographic parameters of a support position (x, y, z)₍ₜ₎ and a source and recording means position (α,β, γ)₍ₜ₎;
   b2) calculating, at a time t, volume V2₍ₜ₎, of volume V1 according to these parameters (x, y, z)₍ₜ₎ and (α, β, γ)₍ₜ₎;
   b3) reading, at a time t, in the storage means of the radiographic parameters of field of view (FOV)₍ₜ₎, focal distance (DF)₍ₜ₎ and object distance (DO)₍ₜ₎;
   b4) calculating, at a time t, a corrected volume V3₍ₜ₎ of volume V2₍ₜ₎ according to these parameters (FOV)₍ₜ₎, (DF)₍ₜ₎ and (DO)₍ₜ₎.
step b) includes the following sub-steps per-operatively:
   b1) reading, at a time t, in the storage means of the radiographic parameters of a support position (x, y, z)₍ₜ₎ and a source and recording means position (α, β, γ)₍ₜ₎;
   b2) calculating, at a time t, volume V2₍ₜ₎ of volume V1 according to these parameters (x, y, z)₍ₜ₎ and (α, β, γ)₍ₜ₎;
   b3) reading, at a time t, in the storage means of the radiographic parameters of field of view (FOV)₍ₜ₎, focal distance (DF)₍ₜ₎ and object distance (DO)₍ₜ₎;
   b4) calculating, at a time t, a corrected volume V3₍ₜ₎ of volume V2₍ₜ₎, according to these parameters (FOV)₍ₜ₎, (DF)₍ₜ₎ and (DO)₍ₜ₎;
   b5) calculating, at a time t, the projected image (IP, IP3)₍ₜ₎, of corrected volume V3₍ₜ₎ according to these parameters (x, y, z)₍ₜ₎, (α, 62 , γ)₍ₜ₎, (FOV)₍ₜ₎, (DF)₍ₜ₎, and (DO)₍ₜ₎.
the corrected volume V3₍ₜ₎ is calculated, per-operatively, at a time t, as a geometric enlargement and a scaling according to the field of view (FOV)₍ₜ₎, focal distance (DF)₍ₜ₎ and object distance (DO)₍ₜ₎ radiographic parameters.
during step b2), a projection image (IP2)₍ₜ₎ of volume V2₍ₜ₎ is also calculated, per-operatively, at a time t, according to the radiographic parameters of a support position (x, y, z)₍ₜ₎ and a source and recording means position (α, β, γ)₍ₜ₎.
during step b5), the image (IP3, IP)₍ₜ₎ is generated, per-operatively, at a time t, by correcting the projection image (IP2)₍ₜ₎ according to the radiographic parameters of the field of view (FOV)₍ₜ₎ the focal distance (DF)₍ₜ₎ and the object distance (DO)₍ₜ₎.
the calculation of correction is performed, per-operatively, at a time t, by use of an enlargement geometrical function.
the calculation of volume V2₍ₜ₎ comprises the following steps, per-operatively:
   determining, at a time t, in volume V1 an incidence axis depending on the radiographic parameters (α, 62 , γ)₍ₜ₎ of the position of the source and recording means;
   determining, at a time t, in volume V1 a center of volume V2₍ₜ₎ depending on the radiographic parameters (x, y, z)₍ₜ₎ of the position of the support; and calculating and reconstructing, at a time t, volume V2₍ₜ₎ from volume V1 according to a reconstruction axis parallel to the incidence axis.
the volume V2₍ₜ₎ has dimensions (nₓ×n_{y}×n_{z}), at a time t, which are defined per-operatively by an operator.
step b) calculating, a volume (V2, V3, VR) of all or part of volume V1 and/or a two-dimensional projection image (IP2, IP3, IP) of all or part of volume V1 is performed per-operatively, in real-time and at any time or continuously.
step a) includes the following sub-steps:
   a1) acquiring of a set of sections through the region of interest; and
   a2) reconstructing volume V1 in the form of a three-dimensional voxel matrix.
step c) includes the following sub-steps, in real-time per-operatively:
   c1) real-time reading, in the storage means of the radiography device, the real-time images (IS1) and/or volumes (VS1) of videoscopy associated with the positions of the support (x, y, z), of the source and recording means (α, β, γ), of the field of view (FOV), of the focal distance (DF) and of the object distance (DO);
   c2) real-time combining the volume (V3) and/or the projection image (IP3) and/or a given plane section in the volume (V3), with the real-time images (IS1) and/or volumes (VS1) of videoscopy, resulting in volume (V4, VRS) and/or projection image (IP4, IR) of volume V4 associated with the positions of the support (x, y, z), of the source and recording means (α, 62 , γ), of the field of view (FOV), of the focal distance (DF) and of the object distance (DO);
during step c2), the image (IP4, IR) is generated, in real-time per-operatively by combining the image (IP3) with the real-time images (IS1) of videoscopy associated with the positions of the support (x, y, z), of the source and recording means (α, 62 , γ), of the field of view (FOV), of the focal distance (DF) and of the object distance (DO);
step c) real-time combining volumes and/or images with volumes and/or images is performed in real-time per-operatively by all combining methods to match volumes and/or images (superpose to, subtract from, fusion with, superimposition to, or associate to, etc.)
step c) real-time combining volumes and/or images with volumes and/or images is performed in real-time per-operatively according to the frequency of images and/or volumes generated by the videoscopy.
by moving the position of the support, the position of the source and recording means, the field of view, the focal distance and/or the object distance, that changes in real-time preoperatively the corresponding engaged radiographic parameters (x, y, z), (α, β, γ), (FOV), (DF) and (DO) and results in displaying in real-time per-operatively on a display device, the video sequence of the volume (VR) and/or the projection image (IP) of volume (VR).
by changing one or several disengaged radiographic parameters (x, y, z), (α, 62 , γ), (FOV), (DF) and (DO) of the radiography device, without moving the position of the support, the position of the source and recording means, the field of view, the focal distance and/or the object distance, that results in displaying in real-time per-operatively on a display device, the video sequence of the volume (VR), the projection image (IP) of volume (VR).
by changing one or several disengaged radiographic parameters (x, y, z), (α, β, γ), (FOV), (DF) and (DO) of the radiography device, without moving the position of the support, the position of the source and recording means, the field of view, the focal distance and/or the object distance that results in moving automatically the device to the corresponding engaged radiographic parameters (x, y, z), (α, β, γ), (FOV), (DF) and (DO);
by generating the videoscopy that result in displaying in real-time per-operatively on a display device, the video sequence of the volume (VR), the projection image (IP) of volume (VR), the volume (VRS) and/or the projection image (IR) of volume (VRS).
step a) volume of the region of interest is V1_{bone} without contrast media from the rotational angiography.
in step b) the volume V2bone₍ₜ₎ has dimensions (n_{x bone}×n_{y bone}×n_{z bone}) larger than the volume V2₍ₜ₎ (nₓ×n_{y}×n_{z}), at a time t, which are defined per-operatively by an operator.
step c) the real-time per-operatively combining volumes and/or images is a subtraction that results in volumes V2_{bone}, V3_{bone}, V⁴_{no bone}, VR_{bone} and VRS_{no bone} and projection image IP2_{bone}, IP3_{bone}, IP4_{no bone}, IP_{bone} and IR_{no bone}.
step c) the real-time per-operatively combining volumes and/or images is a variable weighting of subtraction.
step c) real-time combining the volume (V3) and/or the projection image (IP3) and/or a given plane section in the volume (V3), with the volume (V⁴_{no bone}) and/or the projection image (IP4_{no bone}) and/or a given plane section in the volume (V⁴_{no bone}), result in volume (V4s, VRSs) and/or projection image (IP4s, IRs) of volume V4s associated with the positions of the support (x, y, z), of the source and recording means (α, β, γ), of the field of view (FOV), of the focal distance (DF) and of the object distance (DO);
the signal of all devices newly introduced in the region of interest since acquisition of volume V1_{bone} and viewed by videoscopy is enhanced and improved in real-time by sequences of functions of dilation and erosion (closing algorithm) or by any other method of calculation (enhancement, signal modulation or other) to optimize all parameters of the signal (intensity, contrast and other parameters) of these elements to enhance their visibility.

The present invention also provides a radiography device, comprising an X-ray source, recording means facing said source, a support on which an object to be radiographied, containing a region of interest, can be positioned, characterized in that it comprises three-dimensional data acquisition means connected to the recording means, computing means and display means, said means being together arranged so as to perform, in real-time per-operatively, the method according to any one of the preceding claims.

### BRIEF DESCRIPTION OF THE DRAWINGS

Other features and advantages of the present invention will be described hereafter:

FIG. 1 illustrates the positioning of a region of interest inside a radiography device (of angiography type) according to the invention.

FIG. 2 is a logic diagram of the method according to the present invention.

FIG. 3 is a detailed logic diagram of the various functions of FIG. 2.

FIG. 4a, 4b, 4c illustrate the results of the method according to the invention.

FIGS. 5 and 6 illustrate the calculation of the projection image in MIP (Maximum Intensity Projection) on the basis of the initial volume of the region of interest according to various positions of the radiography device.

FIG. 7 is a logic diagram of the first step of a method according to an embodiment of the present invention.

FIG. 8 is a logic diagram of the second step of a method according to an embodiment of the present invention.

### DETAILED DESCRIPTION

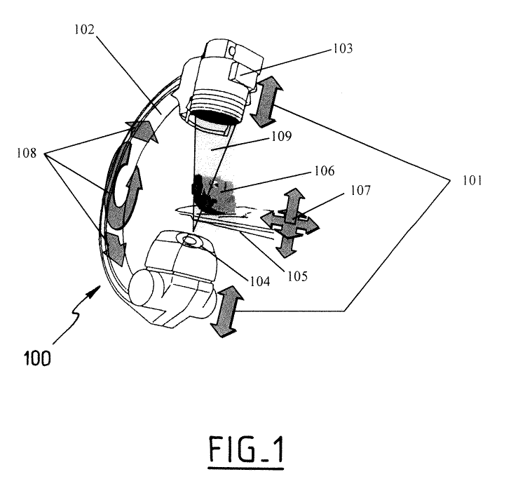

Referring to FIG. 1, we shall hereinafter describe an application frame for the method of the present invention. A radiography device 100 includes a cradle 102 and a support 105, a table in this case, designed to support an object 106, in this case the head of the patient radiographied by radiography device 100 in view of an intervention at the level of a specific anatomic region, for example. Cradle 102, formed in half-circle, includes, at one end a X-ray source 104 and at the other end X-an ray sensor 103 designed for the acquisition of radiographic and radioscopic images in the region of interest positioned in an X-ray cone 109 emitted by source 104. In working position, an active surface of sensor 103 is located opposite X-ray source 104. X-ray source 104 and X-ray sensor 103 can be placed nearer of farther from each other (see arrows 101). The relative positions of X-ray source 104 and X-ray 103 are materialized by the distance between them and are represented by the focal distance parameter (DF) that the angiography device 100 constantly records in the storage means provided for this purpose (not shown). As well, the relative positions of X-ray source 104 and the region of interest of the object 106 to be radiographied are materialized by the distance between them and represented by the object distance parameter (DO) that the angiography device 100 constantly records in storage means provided for this purpose (not shown).

The radiographic parameters are defined as follows:
The reference origin point of the angiography device is the isocenter represented by the point of intersection of virtual lines crossing the axis of the center of the X-ray source and the center of the X-ray detector for two different positions of cradle.
The reference values of the radiographic parameters are those used to carry out image acquisition by rotational angiography.
The spatial coordinate parameter of cradle is determined by angular coordinates (α, β, γ). The origin of angular coordinates (α=0°, β=0°, γ=0°) is defined by the vertical position of the axis that passes through the center of the X-ray source and the center of the X-ray detector corresponding to the vertical position of the cradle.
The spatial coordinate parameter of support (table) is determined by rectangular coordinates (x, y, z). The origin of rectangular coordinates (x=0, y=0, z=0) is defined by the position of the support so that the region of interest is positioned in the isocenter.
The focal distance parameter is determined by the algebraic distance (DF) between the X-ray source and the X-ray detector.
The object distance parameter is determined by the algebraic distance (DO) between the X-ray source and the region of interest of the object to be radiographied.
The field of view parameter is the size of the area (FOV) of the X-ray detector that sees the region of interest of the object.
The time (t) corresponds to the event of a change of one or several (x, y, z)₍ₜ₎, (α, β, γ)₍ₜ₎, (FOV)₍ₜ₎, (DF)₍ₜ₎ and (DO)₍ₜ₎ radiographic parameters.

The field of view, the values of which are predetermined according to radiology equipment 100, is defined by a parameter (FOV) that is constantly recorded by angiography device 100 in storage means provided for this purpose (not shown).

On the other hand, cradle 102 can move according to three rotations of space as illustrated by arrows 108. This spatial position of the cradle is represented by angular coordinates (α, β, γ) constantly recorded by angiography device 100 in storage means provided for this purpose (not shown). Support table 105 can move according to three translations of space illustrated by arrows 107. As previously, the position of support table 105 is represented by rectangular coordinates (x, y, z) constantly recorded in storage means provided for this purpose (not shown).

All these parameters, rectangular coordinates (x, y, z) of table 105, angular coordinates (α, β, γ) of cradle 102, focal distance (DF), object distance (DO) and field of view (FOV) almost permanently changed by the operator during the intervention, will drive the method of this invention which shall now be described.

Definitions:

The reference point 0 of radiography device 100 is the isocenter represented by the point of intersection of virtual lines crossing the axis of the radiogenerating tube that forms X-ray source 104, and the center of the shining amplifier including x-ray sensor 103 for two different positions of cradle 102.

The spatial coordinates of cradle 102 are determined by angular coordinates (α, β, γ). Isocenter 0 represents the position of reference point 0 of cradle 102 in radiography device 100. The origin of angular coordinates (α=0°, β=0°, γ=0°) is defined by the vertical position at 0° of right and left side inclination angle, and front and back (or cranio-caudal or caudo-cranial) longitudinal inclination of cradle 102 in relation to support table 105 designed to support object 106.

The spatial coordinates of table 105 are determined by rectangular coordinates (x, y, z). The position of reference point 0 of table 105 and reference point of rectangular coordinates (x-0, y-0, z-0) depend on the position of table 105 when the region of interest of object 106 is positioned in isocenter 0 to carry out angiography as explained hereafter. The field of view (FOV) parameter of radiography device 100 depends on the characteristics of the radiography equipment and preferentially corresponds to one of values 33, 22, 17 and 13 cm. The FOV reference value is used to carry out image acquisition by rotational angiography.

The focal distance (DF) and object distance (DO) parameters characterize length on the axis of the radiogenerating tube forming X-ray source 104 that passes through the center of the shining amplifier including x-ray sensor 103. The reference values of focal distance (DF) and object distance (DO) are those used to carry out image acquisition by rotational angiography.

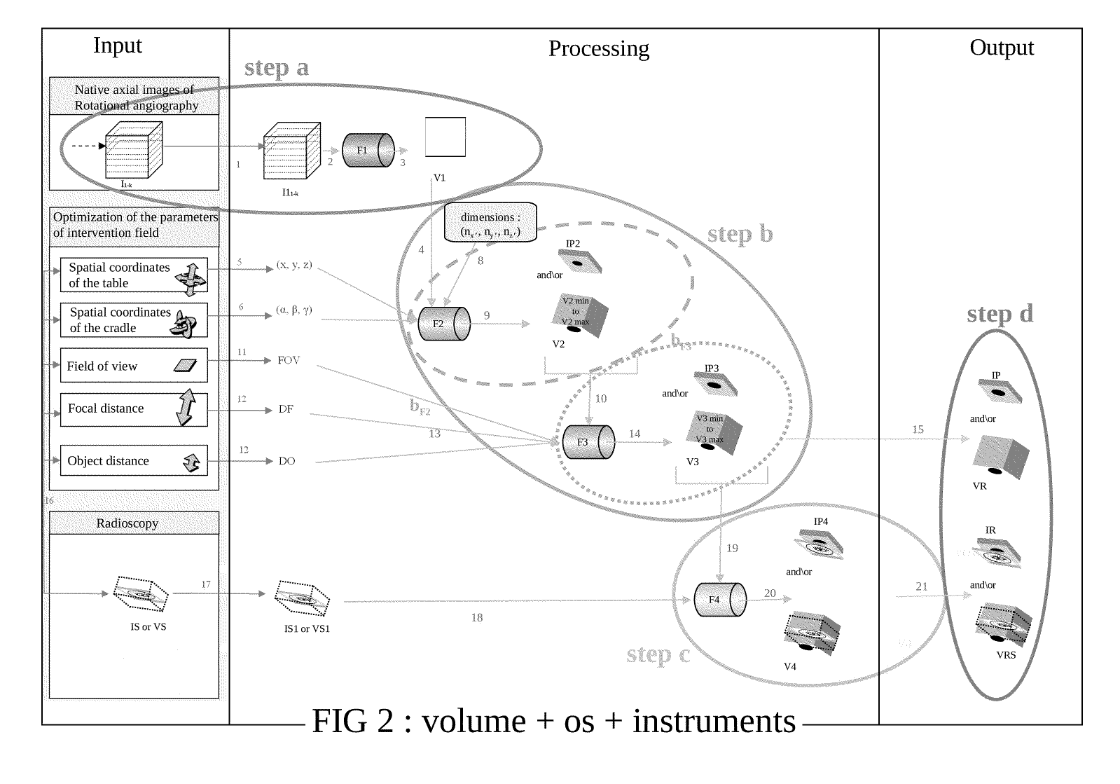

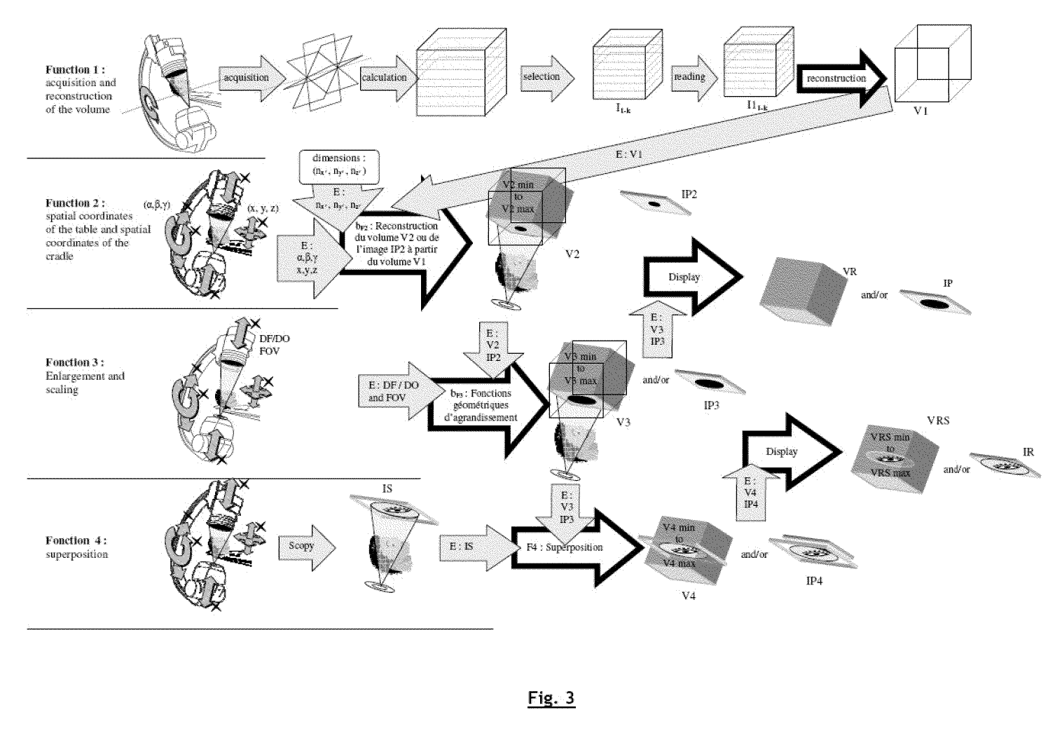

With reference to FIGS. 2 and 3, the method of this invention will now be described. In FIG. 2, the “input” column of the table includes all data provided by radiography device 100, according to the invention. The method of this invention is illustrated in the processing column on FIG. 2. The output column illustrates data provided back to the user according to the invention.

Step a) of the method, previously to the intervention itself, consists in acquiring a number of images in the region of interest and reconstructing a three-dimensional volume V1. The rotational angiography method is usually applied. This method consists in taking a series of native plane projection images of object 106 including the region of interest visualized under various incidence angles according to cradle rotation, with a view to a three-dimensional reconstruction. The region of interest to be reconstructed is positioned in the isocenter, as illustrated in FIG. 1, object 106 is then explored with a series of acquisition of angular native images II 1-i by cradle rotation in a given rotation plane in order to be visualized under various incidence angles. This is illustrated on the first two images of the first line on FIG. 3. During the acquisition of angular native images II 1-i, radiography device 100 has following parameters:
various parameters pre-defined before cradle rotation starts: frequency of image acquisition (FREQ), field of view (FOV), focal distance (DF), object distance (DF) of the region of interest of object to be radiographied from the x-ray source 104, the range of cradle 102 rotation represented by the maximum rotation angle (ANG-MAX), the rotation speed of cradle 102 as well as the rectangular coordinates (x, y, z) of support table 105 so that the region of interest of object 106 to be radiographied is positioned in the isocenter and remains in the field of visualized images during rotation of cradle 102,
variable parameters during rotation of cradle 102 for acquisition of angular coordinates (α, β, γ) of cradle 102 varying in the rotation plan.

The number of images acquired by angle degree is determined by the rotation speed of cradle 102 and image acquisition frequency (FREQ). Total number i of images acquired is determined by the number of images by angle degree and the rotation range of cradle 102 (ANG-MAX). Angular native projection images II 1-i of various incidences in the region of interest of object resulting from rotational angiography acquisition are visualized perpendicular to the rotation plane of cradle 102, under various incidences depending on the position of cradle 102 during rotation, thus making it possible to acquire images under various visual angles.

Then, in the following step, all angular native images II 1-i are changed into axial native images IX 1-j. Angular native projection images II 1-i of various incidences of object 106 including the region of interest, obtained by rotation of cradle 102, are recalculated and reconstructed in axial projection IX 1-j to obtain a series of images following a predetermined axis in view of a three-dimensional reconstruction, considering all or part of XI 1-j images after selection of a series of images I 1-k (k ranging from 1 to j) corresponding to the region of interest. These actions are directly carried out by radiography device 100. All axial native images I 1-k of rotational angiography are acquired following the inventive method. (arrow 1, FIG. 2) with the recording devices of radiography device 100 where they are stocked. The axial native images are then used as input data II 1-k (arrow 2) for a reconstruction function F1. Function F1 is used to carry out three-dimensional reconstruction to obtain a volume of the region of interest of object 106 on the basis of the input data of axial native images II 1-k. Volume V1, corresponding to the output data of function F1 (arrow 3), includes several voxels.

A voxel is the volume unit corresponding to the smallest element of a three-dimensional space, and presents individual characteristics, such as color or intensity. Voxel stands for “volume cell element”. A three-dimensional space is divided into elementary cubes and each object is described by cubes. Volume V1 is a three-dimensional matrix of 1 voxel by h voxels by p voxels. This three-dimensional matrix representing volume V1 is the conclusion of step a) according to the present invention.

Following steps b), c) and d) are preferentially carried out per-operatively, while the patient is operated.

The second step of the method of this invention corresponds to step b) and comprises sub-steps b F2) and F3) corresponding to F2 and F3 described hereafter. During phase b F2), the input data used by function F2 include the three-dimensional matrix of volume V1 (arrow 4) and the rectangular coordinates (x, y, z) (arrow 7), at time t, of support table 105, which are read (arrow 5) in the storage means of the rectangular coordinates of radiography device 100, illustrating the position of table 105 at time t, together with the angular coordinates (α, β, γ) (arrow 7) at time t, of cradle 102, read (arrow 6) in the storage means of radiography device 100, illustrating the position of cradle 102 at time t.

Another input datum may be provided to function F2 (arrow 8) and corresponds to dimensions (nx, ny, nz) of volume V2 calculated and reconstructed by function F2 from volume V1. Parameter nx, ny, nz are variable and determined by the operator himself. These parameters are preferably expressed in voxels and range between 1 voxel and a maximum number of voxels enabling the calculation and reconstruction of volume V2 from volume V1. Minimum volume V2min corresponds to minimum values of (nx, ny, nz) (i.e. 1 voxel) and maximum volume V2max corresponds to the maximum values of (nx, ny, nz) enabling the reconstruction of volume V2 from volume V1.

On the basis of all input data, function F2 calculates and reconstructs, from volume V1 at time t, volume V2 and possibly a projection image IP2 of volume V2 corresponding to coordinates (x, y, z) of table 105 and (α, β, γ) of cradle 102 and to dimensions (nx, ny, nz) of volume V2. When function F2 is completed, the data of volume V2 and possible projection image IP2 of volume V2 are available (volume V2 ranging from volume V2min and volume V2max corresponding to extreme values of nx, ny, nz (arrow 9). Volume V2 is reconstructed from volume V1 and parameterized at time t, by coordinates (x, y, z) of support table 105 and (α, β, γ) of cradle 102, as well as dimensions (nx, ny, nz) ranging from 1 voxel (volume V2min of one voxel reconstructed from volume V1) to maximum dimensions determining volume V2max reconstructed from volume V1.

Calculation and reconstruction of volume V2 from volume V1 are preferably carried out according to the following algorithm:
determination in volume V1 of incidence axis according to (α, β, γ) in relation to the reference system of angiography room 100 (zero point represents the isocenter) and of the position of volume V2 center according to (x, y, z) in relation to the reference system of table support 105 (zero point is determined by the position of the table during acquisition of images used to reconstruct volume V1 of object 106 region of interest, as indicated in previously mentioned definitions;
initiation by the operator or determination of dimensions nx, ny, nz in number of voxels of volume V2 and,
calculation and reconstruction from volume V1, of volume V2 by trilinear interpolation between voxels of a series of voxels of volume V1, with a center of dimension (nx, ny, nz) voxels according to a reconstruction axis represented by previously determined incidence axis.

Projection image IP2 is calculated by projection according to the incidence axis on a plane perpendicular to this axis, of volume V2.

Volume V2 is represented in the form of a three-dimensional matrix of nx voxels by ny voxels by nz voxels. Volume V2 and volume V2 projection image IP2 are used as input data for a function F3 used as input data for a function F3 making following phase bF3) of step b) (arrow 10). Three other parameters are used as input data (arrow 13) for function F3:
Parameter (FOV) (arrow 13), at time t, of field of view, read (arrow 11) in the storage means of this parameter of radiography device 100,
Parameter (DF) (arrow 13), at time t, of focal distance, read (arrow 12) in the storage means of this parameter of radiography device 100, and
Parameter (DO) (arrow 13), at time t, of object distance, read (arrow 12) in the storage means of this parameter of radiography device 100.

The position of the region of interest of object 106 to be radiographied in relation to x-ray source 104 and x-ray sensor 103 at time t determines the geometric enlargement parameter (DF/DO), at time t, defined by the relation between focal distance (DF) at time t, and object distance (DO) at time t.

On the basis of all input data, function F3 calculates, at time t, the geometric enlargement and the scaling of volume V2 reconstructed from volume V1, as well as projection image IP2 of volume 2. According to field of view (FOV), object distance (DO) and focal distance (DF) parameters, function F3 applies geometric enlargement function, in this case Thales geometric function, integrating the fact that the relation between a dimension in volume V2 reconstructed from volume V1 of the region of interest of object 106 or a dimension on projection image IP2 of volume V2, and the dimension in the corresponding zone of the region of interest is equal to the relation between the focal distance (DF) and the object distance (DO) of x-ray source 104 in the zone corresponding to the region of interest of object 106 where dimension is taken into account.

In output (arrow 14), function F3 provides a volume V3 corrected from volume V2 as well as a projection image IP3 of volume V3 or a projection image IP3 corrected from projection image IP2 of volume V2. Volume V3 is a volume calculated and reconstructed from volume V1 and parametered at time t by coordinates (x, y, z) of table 105, and (α, β, γ) of cradle 102, the parameters of geometric enlargement and scaling of field of view (FOV), of object distance (DO) and focal distance (DF) as well as dimensions (nx, ny, nz) ranging from 1 voxel (volume V3min of one voxel reconstructed from volume V1) to maximum dimensions determining volume V3max reconstructed from volume V1. As for volumes V1 and V2, volume V3 has the form of a three-dimensional matrix of voxels.

Once volume V3 and projection image IP3 of volume V3 are calculated, the method of this invention can transfer volume V3 and/or projection image IP3 onto display devices (arrow 15) readable at time t by the user. The user can see, at time t, on the display devices a volume VR of region of interest (volume V3 transmitted) and/or projection image IP (image IP3 transmitted) of the region of interest volume, corresponding to the relative position of support 105, of cradle 102, and the values of field of view (FOV), object distance (DO), focal distance (DF) parameters and dimensions (nx, ny, nz) at the time t. It should be noted that no radiography nor radioscopy device has been used to provide a representation of this volume and/or projection image of this volume.

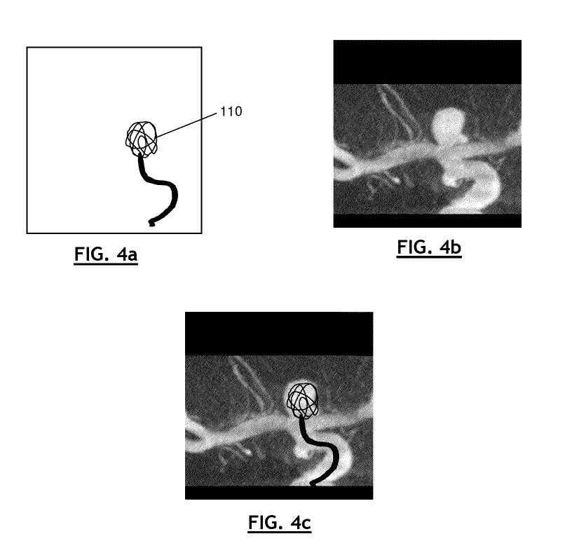

During the intervention, the operator can introduce into the region of interest one or several instruments 110 (FIG. 4a) for which he wants to know exact position at time t. The operator uses the radiography device to get a radioscopic image (IS) (arrow 16) or radioscopic volume (VS) at time t, when cradle 102 has angular coordinates (α, β, γ), support table 105 rectangular coordinates (x, y, z), sensor 103 and x-ray source 104 are positioned so as to read field of view (FOV), object distance (DO) and focal distance (DF). Radioscopic image IS1 is then read (arrow 17) at time t, on the data recording devices of radiography device 100. Data corresponding to radioscopic image IS1 are used as input data (arrow 18) during step c) for a function F4. Function F4 includes as input data: volume V3 and/or projection image IP3 of volume V3 (arrow 19) and radioscopic image IS1, read at time t in the storage means of radiography device 100.

Function F4 carries out superposition or subtraction or fusion, at time t, in volume V3 according to a defined plane section and/or on projection image IP3 of previously calculated volume V3 of radioscopic image IS1 of corresponding parameter settings (arrow 16) in relation to coordinates (x, y, z) of table 105 and (α, β, γ) of cradle 102 as well as values of field of view (FOV), object distance (DO) and focal distance (DF). At time t, function F4 superposes or subtracts in volume V3 according to a defined plane section and/or on projection image IP3 of volume V3, radioscopic image IS1, and/or calculates a projection image IP4 of volume V4 resulting from the superposition or subtraction or fusion in volume V3 according to a defined plane section of radioscopic image IS1 (projection is made in a plane parallel to the plane of radioscopic image IS1 and in a direction perpendicular to radioscopic image IS1. Function F4 provides in output (arrow 20) volume V4 and/or projection image IP4 resulting form previously described superposition or subtraction or fusion. The method of this invention can transfer volume V4 (or volume VRS) and/or projection image IP4 (or image IR) so as to display them (arrow 21) on display devices consulted, at time t, by the operator. In this way, the operator can refer to volume VRS of region of interest and/or projection image IR of region of interest volume corresponding to relative position of support 105, cradle 102 and values of field of view (FOV), object distance (DO), focal distance (DF) parameters and dimensions (nx, ny, nz) at time t. The operator knows the exact position, according to parameters predetermined at time t, of instruments 110 in the region of interest, as illustrated in FIGS. 4a to 4c.

In FIG. 4a, a radioscopic image ISD1 taken at time t is illustrated, visualizing instruments and materials 110. FIG. 4b shows the projection image IP3 of an arterial structure including intracranial aneurism, calculated as previously described, corresponding to parameters (x, y, z), (α, β, γ), (FOV), (DO), (DF) and (nx, ny, nz) associated with radioscopic image IS1 of FIG. 4a. FIG. 4c illustrates a projection image IRS resulting from the superposition carried out by function F4 during step c) when radioscopic image IS1 of FIG. 4a was superposed on projection image IP3 of FIG. 4b, illustrating the way the operator checks the positioning of his instrumentation 110 during an intervention on aneurism.

Then, at time t+δt, the operator:
either displaces his instruments 110 and wants to follow their movement with a new radioscopic image taken at time t+δt, which results in repeating, at time t+δt, previously described step c) and displaying, at time t+δt, volume VRS and/or projection image IR;
and/or modifies the relative position of cradle 102 and/or table 105, which results in repeating at time t+δt, phase bF2 of step b, and displaying volume VR and/or projection image IP. A new radioscopic image input implements step c);
and/or modifies focal distance (DF) and/or object distance (DO), which results in repeating, at time t+δt, phase bF3 of step b) and displaying, at time t+δt, volume VR and/or projection image IP. A new radioscopic image input implements step c).

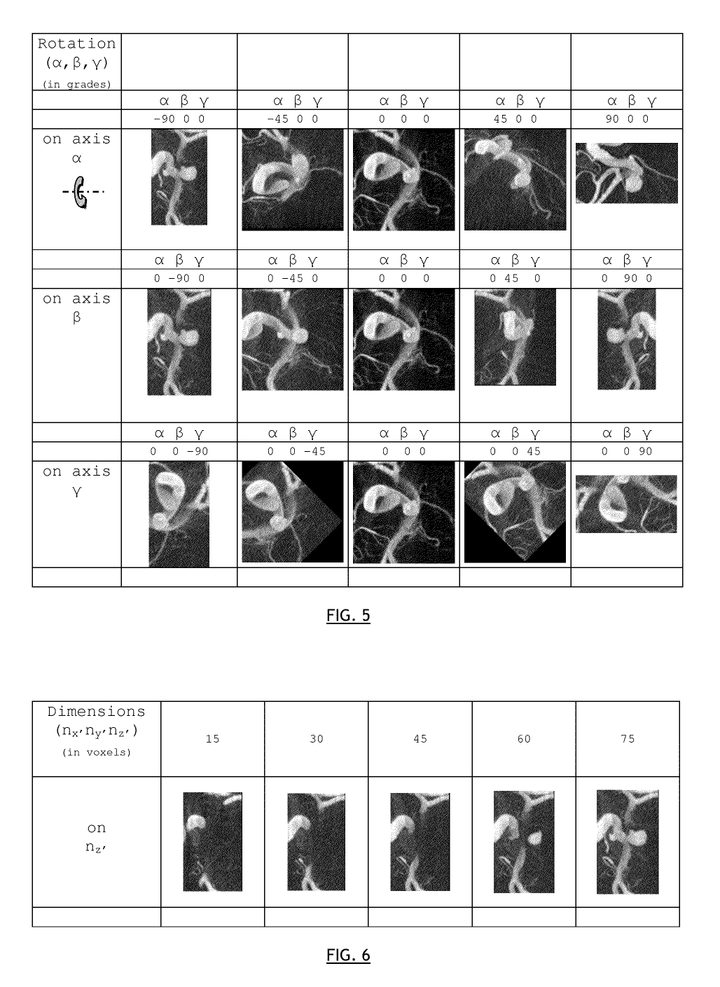

In the given example, FIGS. 5 and 6 represent the result of the calculation of a projection image IP according to different positions of cradle 102. The first line of images of FIG. 5 corresponds to a variation of cradle 102 angle α to −90°, −45°, 0°, 45° and 90° while other angles β, γ are still equal to 0°. The second line of images illustrates a similar variation of angle β while α and γ are fixed to 0°. For the third line of images, α, β are fixed to 0° and γ varies. For all images, the size of initial volume V1 is: I=256 voxels by h=256 voxels by p=153 voxels.

FIG. 6 illustrates, for fixed spatial coordinates (α, β, γ) and (x, y, z), the calculation of a projection image IP according to different values of nz′ (nx′ and ny′ are unchanged), respectively 15 voxels, 30 voxels, 45 voxels, 60 voxels and 75 voxels.

In a practical and preferred manner, to validate the above-described method, the programmation language used is the Java language. It is made from the association of several software modules or plug-ins, each adding functionalities as previously described.

Preferably, they make it possible to use basic functions for processing images of any format, especially DICOM format used in radiology. Basic functions consist in reading, displaying, editing, analyzing, processing, saving and printing images. It is possible to make statistics on a pixel, or a voxel, or on a defined area. Distance and angle measures can be made, together as processing of densities and main standard imaging functions such as contrast modification, edge or median filter detection. They can also carry out geometric modifications such as enlargement, change of scale, rotation; every previous analysis and processing function can be used for any enlargement.

In addition, every function specific to the inventive method is implemented by a dedicated plug-in. Preferentially, a plug-in can calculate and reconstruct orthogonal sections in relation to a give volume or region axis.

Another plug-in calculates and reconstructs a volume, and associated projection image, by modifying the picture on every group of voxels and/or sections. This plug-in reconstructs volume according to a given axis. Volume can be turned, enlarged, or reduced. Volume interpolation is a three-linear interpolation, except from end-of-pile sections and/or end voxels where three-linear interpolation is impossible. In this case, an interpolation of the nearest neighbor is used.

Another plug-in can make a projection according to an axis, in maximum projection intensity (MIP) for example. Projection image IP3 of volume V3 can be calculated in this way.

The inventive method implements many previously described plug-ins to calculate a volume projection image. In the case of a value modification of parameters (x, y, z) of table support 105 position, or position (α, β, γ) of cradle 102, or field of view (FOV), object distance (DO) in relation to the source, focal distance (DF) or dimensions (nx, ny, nz) of studied volume, (nx, ny, nz) defined by the operator, the inventive method implements the volume reconstruction plug-in, recalculated according to the angular projection (α, β, γ) of the region of interest, then calculates enlargement and scaling in relation to the field of view (FOV) and the relation between focal distance (DF) by object distance (DO) in relation to the source, and then, with the projection plug-in, calculates volume projection image and displays projection image IP of this volume on display devices after or not superposition or subtraction or fusion of associated radioscopic image IS1.

Three-dimensional imaging acquired by rotational angiography provides better understanding of the real anatomy of a wound or anatomic structure by showing every angle required. It can be used for diagnosis. From the therapeutic point of view, its use is limited to the optimization of viewing angles, either before treatment to define a therapeutic strategy a priori, or after treatment to evaluate the therapeutic result. The implementation of reference three-dimensional imaging in per-therapy is a new concept, never used before in projection imaging, to adapt and adjust decisions and strategies, assist and control technical intervention and evaluate therapeutic results.

An implementation frame for the inventive method is described according to a projection imaging technique using an angiography device, for the investigation and endovascular treatment of an intracranial aneurism. The region of interest is represented by the corresponding intra-cranial arterial vascular structure showing intra-cranial aneurism.

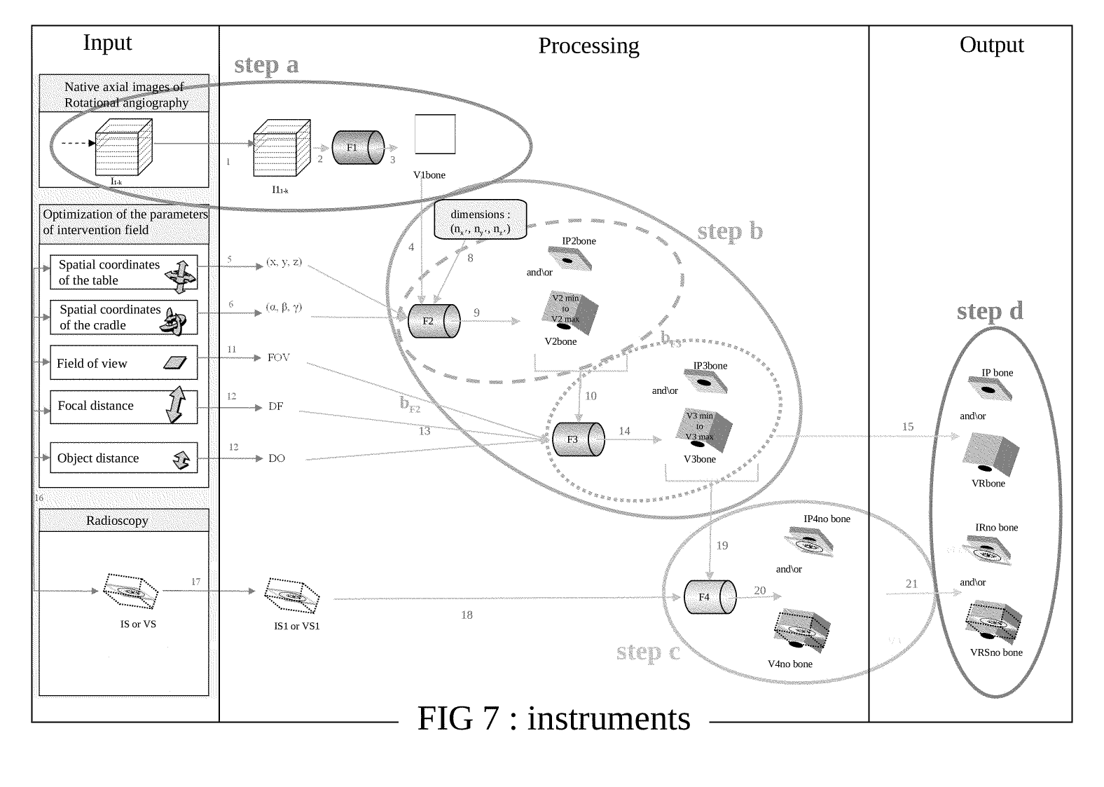

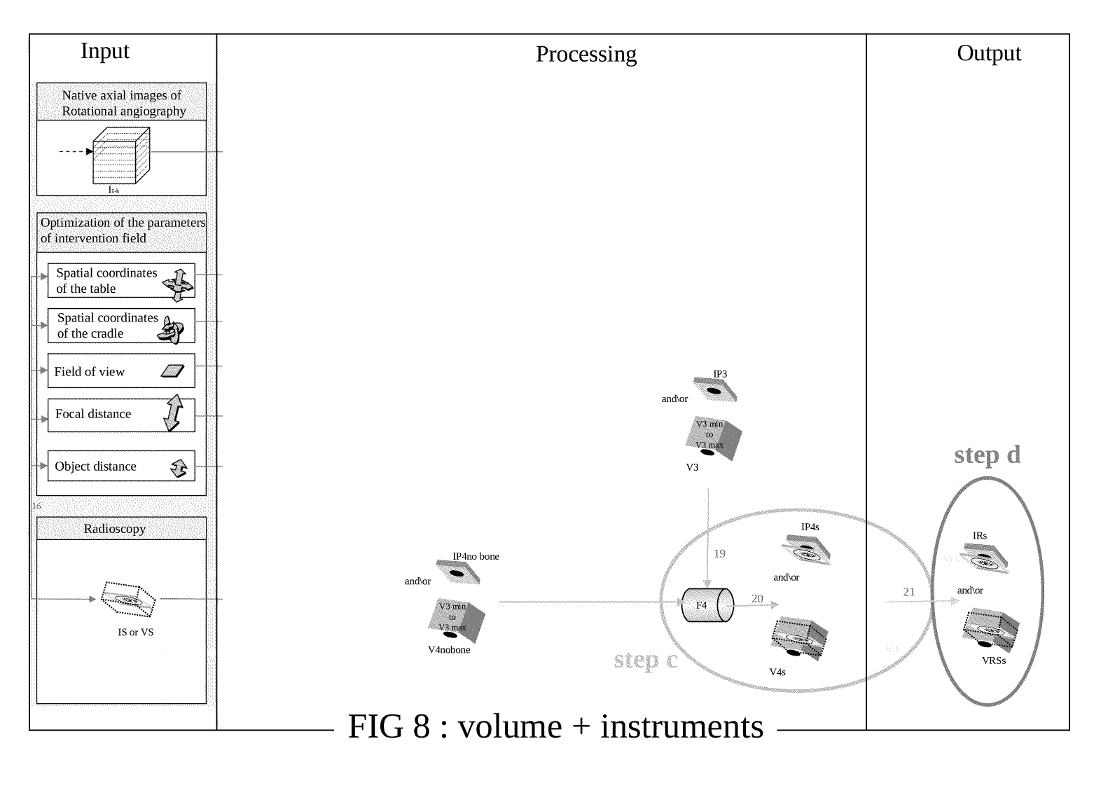

In this case, an embodiment of the method according of the invention can help in seeing inside the crane. This method is illustrated by the FIG. 7 and the FIG. 8. So the volume of the region of interest is V1_{bone} without contrast media from the rotational angiography.

Then the sub-volume V2bone₍ₜ₎ of said volume V1_{bone} has dimensions (n_{x bone}×n_{y bone}×n_{z bone}) larger than the volume V2₍ₜ₎ (nₓ×n_{y}×n_{z}), at a time t, which are defined per-operatively by an operator.

The method of the invention allows to “remove” the bones (the crane) to see only the instruments during the surgery. The corresponding step is a subtraction that results in volumes V2_{bone}, V3_{bone}, V4_{no bone}, VR_{bone} and VRS_{no bone} and projection image IP2_{bone}, IP3_{bone}, IP⁴no bone, IP_{bone} and IR_{no bone}, which are represented in FIG. 7.

This step can also be a variable weighting of subtraction, in order to have a partial removing of bones.

During said step, real-time combining the volume (V3) and/or the projection image (IP3) and/or a given plane section in the volume (V3), with the volume (V4_{no bone}) and/or the projection image (IP4_{no bone}) and/or a given plane section in the volume (V4_{no bone}), can result in volume (V4s, VRSs) and/or projection image (IP4s, IRs) of volume V4s associated with the positions of the support (x, y, z), of the source and recording means (α, β, γ), of the field of view (FOV), of the focal distance (DF) and of the object distance (DO). This step allows to combine the view of instruments obtained after the method of FIG. 7, and the volume, in our case the vascular structure. Said combined view allows to easily visualize both an intro-cranial aneurism and the instruments moved by the surgeon to treat it.

In a particularly preferred embodiment, the signal of all devices newly introduced in the region of interest since acquisition of volume V1_{bone} and viewed by videoscopy is enhanced and improved in real-time by sequences of functions of dilation and erosion (closing algorithm) or by any other method of calculation (enhancement, signal modulation or other) to optimize all parameters of the signal (intensity, contrast and other parameters) of these elements to enhance their visibility.

These functions are known by a man skilled in mathematical morphology, and are very effective for the processing and analysis of geometrical structures.

In the medical domain, images used for reconstruction of the region of interest volume in three dimensions can be acquired by imaging techniques, including endo-virtual reconstruction methods:
1) projection imaging techniques such as previously described rotational angiography,
2) section imaging techniques such as computerized tomodensimetry or scanner, magnetic resonance imaging or ultra-sound imaging,
3) video imaging techniques,
4) virtual digital imaging techniques.

Images used for three-dimensional reconstruction of region of interest volume can be acquired from any previously described techniques.

Real-time active images can be:
1) radioscopic for radiology and angiography techniques,
2) cinescopic for imaging techniques of computerized tomodensimetry or scanographic, by magnetic resonance, or ultrasound,
3) videoscopic for video imaging techniques such as endoscopy or coelioscopy,
4) digital for digital camera or virtual digital images.

Real-time active images can be two-dimensional, stereoscopic or three-dimensional images, preferably real-time active images are real-time images (IS1) of videoscopy associated with the positions of the support (x, y, z), of the source and recording means (α, β, γ), of the field of view (FOV), of the focal distance (DF) and of the object distance (DO);

The imaging technique producing real-time active images and the technique used for acquisition in the frame of three-dimensional reconstruction of region of interest volume can rely on one or several techniques, then requiring a positioning of the region of interest volume according to an internal or external reference system.

The step of real-time combining volumes and/or images with volumes and/or images can be performed in real-time per-operatively by previously described combining methods to match volumes and/or images (superpose to, subtract from, fusion with, superimposition to, or associate to, etc.) This step is preferably performed according to the frequency of images and/or volumes generated by the videoscopy.

The radiographic parameters can be engaged or disengaged.

They are engaged when they are connected to the radiography device and correspond to the real position of the support, the position of the source with recording means, the field of view, the focal distance and the object distance. By moving the position of the support, the position of the source and recording means, the field of view, the focal distance and/or the object distance, that changes in real-time preoperatively the corresponding engaged radiographic parameters (x, y, z), (α, β, γ), (FOV), (DF) and (DO) and results in displaying in real-time per-operatively on a display device, the video sequence of the volume (VR) and/or the projection image (IP) of volume (VR).

To the contrary, these radiographic parameters are disengaged when they are disconnected to the radiography device and correspond to the virtual positions of the device. And by changing one or several disengaged radiographic parameters (x, y, z), (α, β, γ), (FOV), (DF) and (DO) of the radiography device, without moving the position of the support, the position of the source and recording means, the field of view, the focal distance and/or the object distance, that results in displaying in real-time per-operatively on a display device, the video sequence of the volume (VR), the projection image (IP) of volume (VR). It is useful for example for quickly observing a detail of the displayed area without having to move the whole device.

In a preferred embodiment, when the radiographic parameters are reengaged after having changed one or several disengaged radiographic parameters (x, y, z), (α, β, γ), (FOV), (DF) and (DO) of the radiography device without moving the position of the support, the position of the source and recording means, the field of view, the focal distance and/or the object distance, the device can then move automatically to the corresponding newly engaged radiographic parameters (x, y, z), (α, β, γ), (FOV), (DF) and (DO);

Display devices can include:
1) two-dimension displays providing volume projection images,
2) three-dimension simulated displays giving an impression of volume,
3) three-dimension displays (new technologies, such as holography systems) where several volumes can be mixed, added or subtracted.

During interventional radiology procedures supported with the inventive method, real-time data acquisition concerning the third dimension of the studied anatomic region considered as a whole (volume and volume projection image of the region of interest) or partly by showing a hidden zone of the studied anatomic region (volume and volume projection image of a part of the region of interest), in real-time (i.e. in per-procedure with almost instant response), dynamically (i.e. changing in case of modification in the parameterization of image acquisition system such as table or cradle position, values of field of view, focal distance of x-ray source from recording devices, or distance between the region of interest and x-ray source in the case of angiography device), interactively (i.e. responsive to the operator request), under every viewing angle (i.e. corresponding to every possible incidence angle in radiography or radioscopy in the case of angiography device, for example), which, when they are superposed on or subtracted from instrument and radio-opaque equipment image data obtained by subtracted or non-subtracted active radioscopic image, provide optimization of data concerning the region of interest and the position of instruments and radio-opaque equipment in the region of interest and allow the operator to make adapted decisions in real-time, in the course of the investigation or intervention concerning the definition of relevant investigation or intervention fields of view in the region of interest, investigation or intervention strategies, instrumentation guiding, technical gesture control and evaluation. Consequently, investigation or intervention safety and efficiency are optimized, intervention is shorter, the quantities of injected contrast substance and irradiation of patient and operator are reduced.

Naturally, modifications can be made within the frame of the present invention.

1. A real-time method for navigation inside a region of interest, for use in a radiography unit including an X-ray source with an X-ray detector facing the source (cradle), and a support (table) on which an object to be radiographied, containing the region of interest, can be positioned.
The method comprising the following steps:
a) acquiring three-dimensional image data of a volume V1 of the region of interest;
b) per-operatively, calculating, at a time t, a volume (V2, V3) of all or part of volume V1 and/or a two-dimensional projection image (IP2, IP3) of all or part of volume V1 according to the radiographic parameters of the position of the support, the position of the source and recording means, a field of view (FOV), a focal distance (DF) and an object distance (DO);
c) per-operatively, real-time combining the volume (V3) and/or the projection image (IP3) and/or a given plane section in the volume (V3), with the real-time images (IS1) and/or volumes (VS1) of videoscopy, resulting in volume (V4) and/or projection image (IP4) of volume V4 associated with the positions of the support, of the source and recording means, of the field of view (FOV), of the focal distance (DF) and the object distance (DO);
d) per-operatively, real-time displaying on a display device, the video sequence of the volume (VR) and/or the projection image (IP) resulting from step b);
e) per operatively, real-time displaying on a display device, the video sequence of the volume (VRS) and/or the image (IR) resulting from step c)

2. A method according to claim 1, characterized in that step b) includes the following sub-steps, per-operatively:
b1) reading, at a time t, in the storage means of the radiographic parameters of a support position (x, y, z)₍ₜ₎, a source and recording means position (α, β, γ)₍ₜ₎, the field of view (FOV)₍ₜ₎, the focal distance (DF)₍ₜ₎ and the object distance (DO)₍ₜ₎; and
b2) calculating, at a time t, volume (V3, VR)₍ₜ₎ and/or the projection image (IP, IP3)₍ₜ₎ according to the read parameters (x, y, z)₍ₜ₎, (α, β, γ)₍ₜ₎, (FOV)₍ₜ₎, (DF)₍ₜ₎ and (DO)₍ₜ₎.

3. A method according to any one of claims 1 and 2, characterized in that step b) includes the following sub-steps per-operatively:
b1) reading, at a time t, in the storage means of the radiographic parameters of a support position (x, y, z)₍ₜ₎ and a source and recording means position (α, β, γ)_{(t);}
b2) calculating, at a time t, volume V2₍ₜ₎, of volume V1 according to these parameters (x, y, z)₍ₜ₎ and (α, β, γ)₍ₜ₎;
b3) reading, at a time t, in the storage means of the radiographic parameters of field of view (FOV)₍ₜ₎, focal distance (DF)₍ₜ₎ and object distance (DO)₍ₜ₎;
b4) calculating, at a time t, a corrected volume V3₍ₜ₎ of volume V2₍ₜ₎ according to these parameters (FOV)₍ₜ₎, (DF)₍ₜ₎ and (DO)₍ₜ₎.

4. A method according to any one of claims 1 and 2, characterized in that step b) includes the following sub-steps per-operatively:
b1) reading, at a time t, in the storage means of the radiographic parameters of a support position (x, y, z)₍ₜ₎ and a source and recording means position (α, β, γ)₍ₜ₎;
b2) calculating, at a time t, volume V2₍ₜ₎ of volume V1 according to these parameters (x, y, z)₍ₜ₎ and (α, β, γ)₍ₜ₎;
b3) reading, at a time t, in the storage means of the radiographic parameters of field of view (FOV)₍ₜ₎, focal distance (DF)₍ₜ₎ and object distance (DO)₍ₜ₎;
b4) calculating, at a time t, a corrected volume V3₍ₜ₎ of volume V2₍ₜ₎, according to these parameters (FOV)₍ₜ₎, (DF)₍ₜ₎ and (DO)₍ₜ₎;
b5) calculating, at a time t, the projected image (IP, IP3)₍ₜ₎, of corrected volume V3₍ₜ₎ according to these parameters (x, y, z)₍ₜ₎, (α, β, γ)₍ₜ₎, (FOV)₍ₜ₎, (DF)₍ₜ₎, and (DO)₍ₜ₎.

5. A method according to one of claims 3 and 4, characterized in that the corrected volume V3₍ₜ₎ is calculated, per-operatively, at a time t, as a geometric enlargement and a scaling according to the field of view (FOV)₍ₜ₎, focal distance (DF)₍ₜ₎ and object distance (DO)₍ₜ₎ radiographic parameters.

6. A method according to one of claims 3 and 4, characterized in that, during step b2), a projection image (IP2)₍ₜ₎ of volume V2₍ₜ₎ is also calculated, per-operatively, at a time t, according to the radiographic parameters of a support position (x, y, z)₍ₜ₎ and a source and recording means position (α, β, γ)₍ₜ₎.

7. A method according to claim 6, characterized in that, during step b5), the image (IP3, IP)₍ₜ₎ is generated, per-operatively, at a time t, by correcting the projection image (IP2)₍ₜ₎ according to the radiographic parameters of the field of view (FOV)₍ₜ₎ the focal distance (DF)₍ₜ₎ and the object distance (DO)₍ₜ₎.

8. A method according to one of claim 5 or 7, characterized in that the calculation of correction is performed, per-operatively, at a time t, by use of an enlargement geometrical function.

9. A method according to any one of claims from 1 to 8, characterized in that the calculation of volume V2₍ₜ₎ comprises the following steps, per-operatively:
i) determining, at a time t, in volume V1 an incidence axis depending on the radiographic parameters (α, β, γ)₍ₜ₎ of the position of the source and recording means;
ii) determining, at a time t, in volume V1 a center of volume V2₍ₜ₎ depending on the radiographic parameters (x, y, z)₍ₜ₎ of the position of the support; and
iii) calculating and reconstructing, at a time t, volume V2₍ₜ₎ from volume V1 according to a reconstruction axis parallel to the incidence axis.

10. A method according to any one of claims 3 to 8, characterized in that the volume V2₍ₜ₎ has dimensions (nₓ×n_{y}×n_{z}), at a time t, which are defined per-operatively by an operator.

11. A method according to any one of the preceding claims, characterized in that step b) calculating, a volume (V2, V3, VR) of all or part of volume V1 and/or a two-dimensional projection image (IP2, IP3, IP) of all or part of volume V1 is performed per-operatively, in real-time and at any time or continuously.

12. A method according to any one of the preceding claims, characterized in that step a) includes the following sub-steps:
a1) acquiring of a set of sections through the region of interest; and
a2) reconstructing volume V1 in the form of a three-dimensional voxel matrix.

13. A method according to any one of claims 1 to 12, characterized in that step c) includes the following sub-steps, in real-time per-operatively:
c1) real-time reading, in the storage means of the radiography device, the real-time images (IS1) and/or volumes (VS1) of videoscopy associated with the positions of the support (x, y, z), of the source and recording means (α, β, γ), of the field of view (FOV), of the focal distance (DF) and of the object distance (DO);
c2) real-time combining the volume (V3) and/or the projection image (IP3) and/or a given plane section in the volume (V3), with the real-time images (IS1) and/or volumes (VS1) of videoscopy, resulting in volume (V4, VRS) and/or projection image (IP4, IR) of volume V4 associated with the positions of the support (x, y, z), of the source and recording means (α, β, γ), of the field of view (FOV), of the focal distance (DF) and of the object distance (DO);

14. A method according to one of claims 4 to 13, characterized in that, during step c2), the image (IP4, IR) is generated, in real-time per-operatively by combining the image (IP3) with the real-time images (IS1) of videoscopy associated with the positions of the support (x, y, z), of the source and recording means (α, β, γ), of the field of view (FOV), of the focal distance (DF) and of the object distance (DO);

15. A method according to one of claims 1 to 14, characterized in that step c) real-time combining volumes and/or images with volumes and/or images is performed in real-time per-operatively by all combining methods to match volumes and/or images (superpose to, subtract from, fusion with, superimposition to, or associate to, etc.)

16. A method according to one of claims 1 to 15, characterized in that step c) real-time combining volumes and/or images with volumes and/or images is performed in real-time per-operatively according to the frequency of images and/or volumes generated by the videoscopy.

17. A method according to one of claims 1 to 16, characterized in that by moving the position of the support, the position of the source and recording means, the field of view, the focal distance and/or the object distance, that changes in real-time preoperatively the corresponding engaged radiographic parameters (x, y, z), (α, β, γ), (FOV), (DF) and (DO) and results in displaying in real-time per-operatively on a display device, the video sequence of the volume (VR) and/or the projection image (IP) of volume (VR).

18. A method according to claims 1 to 16, characterized in that by changing one or several disengaged radiographic parameters (x, y, z), (α, β, γ), (FOV), (DF) and (DO) of the radiography device, without moving the position of the support, the position of the source and recording means, the field of view, the focal distance and/or the object distance, that results in displaying in real-time per-operatively on a display device, the video sequence of the volume (VR), the projection image (IP) of volume (VR).

19. A method according to claim 18 characterized in that by changing one or several disengaged radiographic parameters (x, y, z), (α, β, γ), (FOV), (DF) and (DO) of the radiography device, without moving the position of the support, the position of the source and recording means, the field of view, the focal distance and/or the object distance that results in moving automatically the device to the corresponding engaged radiographic parameters (x, y, z), (α, β, γ), (FOV), (DF) and (DO);

20. A method according to one of claims 1 to 19 characterized in that by generating the videoscopy that result in displaying in real-time per-operatively on a display device, the video sequence of the volume (VR), the projection image (IP) of volume (VR), the volume (VRS) and/or the projection image (IR) of volume (VRS).

21. A method according to claims 1 to 20 and characterized in that step a) volume of the region of interest is V1_{bone} without contrast media from the rotational angiography.

22. A method according to claim 21 and characterized in that in step b) the volume V2bone₍ₜ₎ has dimensions (n_{x bone}×n_{y bone}×n_{z bone}) larger than the volume V2₍ₜ₎ (nₓ×n_{y}×n_{z}), at a time t, which are defined per-operatively by an operator.

23. A method according to one of claims 21 and 22 and characterized in that step c) the real-time per-operatively combining volumes and/or images is a subtraction that results in volumes V2_{bone}, V3_{bone}, V⁴_{no bone}, VR_{bone} and VRS_{no bone} and projection image IP2_{bone}, IP3_{bone}, IP⁴no bone, IP_{bone} and IR_{no bone}.

24. A method according to one of claims 21 to 23 and characterized in that step c) the real-time per-operatively combining volumes and/or images is a variable weighting of subtraction.

25. A method according to one of claims 21 to 25 and characterized in that step c) real-time combining the volume (V3) and/or the projection image (IP3) and/or a given plane section in the volume (V3), with the volume (V4_{no bone}) and/or the projection image (IP4_{no bone}) and/or a given plane section in the volume (V4_{no bone}), result in volume (V4s, VRSs) and/or projection image (IP4s, IRs) of volume V4s associated with the positions of the support (x, y, z), of the source and recording means (α, β, γ), of the field of view (FOV), of the focal distance (DF) and of the object distance (DO);

26. A method according to claim one of claims 21 to 25 and characterized in that the signal of all devices newly introduced in the region of interest since acquisition of volume V1_{bone} and viewed by videoscopy is enhanced and improved in real-time by sequences of functions of dilation and erosion (closing algorithm) or by any other method of calculation (enhancement, signal modulation or other) to optimize all parameters of the signal (intensity, contrast and other parameters) of these elements to enhance their visibility.

27. A radiography device, comprising an X-ray source, recording means facing said source, a support on which an object to be radiographied, containing a region of interest, can be positioned, characterized in that it comprises three-dimensional data acquisition means connected to the recording means, computing means and display means, said means being together arranged so as to perform, in real-time per-operatively, the method according to any one of the preceding claims.
